(19) United States
(12) Patent Application Publication
(10) Pub. No.: US 2011/0036034 A1
(43) Pub. Date: Feb. 17, 2011

(54) INSULATION APPARATUS AND METHOD

(76) Inventor: Raymond Robinson, Cumbria (GB)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 12/735,646

(22) PCT Filed: Jan. 30, 2009
(86) PCT No.: PCT/GB2009/050087

§ 371 Date: Oct. 29, 2010

(30) Foreign Application Priority Data
Feb. 4, 2008 (GB) 0801981.2
May 28, 2008 (GB) 0809626.5

(51) Int. Cl. E04B 1/74; B23P 13/04

(52) U.S. Cl. 52/404.3; 52/742.1; 29/558

(57) ABSTRACT

The apparatus for supporting insulation (5) comprising a base portion, at least one side wall (3′) and at least one supporting flange (2). In an in use position the at least one side wall is substantially perpendicular to the base portion and in a storage position the at least one side wall and the at least one supporting flange are substantially parallel to the base portion. An insulation system and a method of insulating a structure using such apparatus.

### FIELD OF THE INVENTION

The invention relates to an insulation apparatus, in particular an apparatus for supporting insulating materials in buildings. The invention also relates to an insulation system and a method of insulating a structure.

### BACKGROUND OF THE INVENTION

Insulation is added to buildings to conserve energy by preventing heat loss through floors, walls, ceilings and lofts. As well as thermal insulation, buildings may be insulated to prevent noise.

Common forms of insulating materials include polystyrene, fibreglass, foam, plastic fibres or natural fibres. They may come in the form of blocks, boards, rolls, loose fill, foam, batts etc.

The conventional way to lay insulation, for example under a floor, is to lay nets across floor joists and pack insulation between the floor joists. The nets are required to hold the insulation in place and prevent it from falling through the space between joists. This method is time consuming as nets must first be laid and then sufficient insulation material must be tightly packed onto the net between the joists. A disadvantage of this method is that it often leads to ineffective insulation where the ends of the insulation material become compressed due to positioning on the nets.

Another conventional method of laying insulation is to support the insulation on lats which are screwed to opposing surfaces on floor joists. Again, attaching the lats and packing the material onto them can be time consuming and this method is sometimes ineffective as it is possible for the insulation to fall between floor joists.

A further disadvantage associated with both of the above methods is that pipes such as water or heating pipes often run at or below the level of insulation. Insulation may need to be removed to insert pipes after the building has been insulated. Also, access to pipes for maintenance or repair may be restricted or may require removal of a section of insulation and support.

It would therefore be desirable to provide an improved insulation support apparatus.

### SUMMARY OF THE INVENTION

One aspect of the invention provides apparatus for supporting insulation as specified in Claim 1.

Another aspect of the invention provides apparatus for supporting insulation as specified in Claim 17.

Another aspect of the invention provides an insulation system as specified in Claim 19.

Another aspect of the invention provides a method of insulating a structure as specified in Claim 21.

Yet another aspect of the invention provides an insulated structure as specified in Claim 22

Yet another aspect of the invention provides a method of manufacture as specified in Claim 23.

The invention provides an insulation support apparatus comprising an insulation holding portion and at least one supporting flange.

The apparatus for supporting insulation comprises a base portion, at least one side wall and at least one supporting flange.

In an in use position the at least one side wall is substantially perpendicular to the base portion and in a storage position the at least one side wall and the at least one supporting flange are substantially parallel to the base portion.

Advantageously, the apparatus is biased towards the in use position.

In a preferred embodiment, at least one cut or score line facilitates biasing of the apparatus towards the in use position.

Preferably, the apparatus is formed substantially from a double skinned material.

The double skinned material may comprise a first surface layer and a second surface layer with connecting elements between the layers.

In a preferred embodiment, a portion of one surface layer is substantially weaker than a corresponding portion of the other surface layer.

Preferably, the apparatus comprises at least one cut or score line in the first surface layer and at least one cut or score line in the second surface layer.

Advantageously, the cut or score line forms a pivot point about which the apparatus is pivotable.

At least one supporting flange may be pivotable towards the at least one side wall.

At least one side wall may be pivotable towards the base portion.

In one embodiment the apparatus may also comprise insulating material.

Preferably, the supporting flange or flanges is/are arranged to engage a structural element of a building such as a joist or cladding.

In a preferred embodiment, at least one portion of the apparatus is complementary to a portion of another apparatus. The apparatus may have an extending portion at one end, which may be arranged to engage a receiving portion of an adjacent apparatus when in use.

Advantageously, each flange may include a region complementary to another flange such that the apparatus may co-operate with an adjacent support apparatus. Adjacent flanges may have overlapping and/or interlocking regions.

Preferably, the insulation holding portion comprises a base and at least one side wall extending from at least one flange. The insulation holding portion may be formed of plastic and/or mesh. The insulation holding portion may be in the form of a trough.

In a preferred embodiment the support apparatus includes strengthening elements such as ribs.

The support may be formed of double skinned plastic. The plastic may be recycled plastic.

Preferably the support and/or the insulation holding portion are substantially rigid.

The side walls may be foldable towards the base of the insulation holding portion. The flanges may be foldable toward the base and/or the sidewalls.

Advantageously, the support apparatus may comprise openings. The openings may be holes or open regions in a mesh.

The openings may be arranged to accommodate pipes such as water pipes or cables.

Advantageously, the support apparatus may comprise sound deadening elements, such as one or more layers of sound deadening materials.

Another aspect of the invention provides an insulation system comprising more than one apparatus for supporting insulation.

Advantageously the insulation system is coded such that apparatus is readily identifiable. Preferably the system provides easy identification of each apparatus, with or without insulation, according to its properties.

In a preferred embodiment the insulation system is colour coded.

Another aspect of the invention provides a method of insulating a structure such as a building, comprising the steps of a) engaging at least one supporting flange of an apparatus for supporting insulation with a structural element of a building and b) securing the apparatus to the structural element of a building.

Yet another aspect of the invention provides an insulated structure comprising structural elements, at least one support apparatus and insulating material.

An aspect of the invention may provide apparatus for supporting insulation comprising a base portion and at least one side wall, wherein in an in use position the at least one side wall is substantially perpendicular to the base portion and in a storage position the at least one side wall is parallel to the base portion and wherein the apparatus is formed substantially from double skinned material.

A portion of one surface layer of the double skinned material is preferably substantially weaker than a corresponding portion of the other surface layer.

Yet another aspect of the invention may provide a method of manufacture of apparatus for supporting insulation comprising the steps of:
i) cutting or scoring a first surface of a double skinned material to define a supporting flange portion
ii) cutting or scoring a second surface of a double skinned material to define a side wall portion and base portion.

### BRIEF DESCRIPTION OF THE DRAWINGS

FIG. 1a shows a schematic representation of one embodiment of the invention

FIG. 1b shows a side view of the invention of FIG. 1a

FIG. 2a shows a side view of the invention of FIG. 1a.

FIG. 2b shows a side view of the invention of FIG. 1a.

FIG. 3a shows a schematic representation of the invention of FIG. 1a.

FIG. 3b shows a schematic representation the invention of FIG. 1a.

FIG. 3c shows a schematic representation of the invention of FIG. 1a.

FIG. 4 shows an alternative embodiment of the invention.

FIG. 5 shows an alternative embodiment of the invention.

### DETAILED DESCRIPTION OF THE PREFERRED EMBODIMENTS

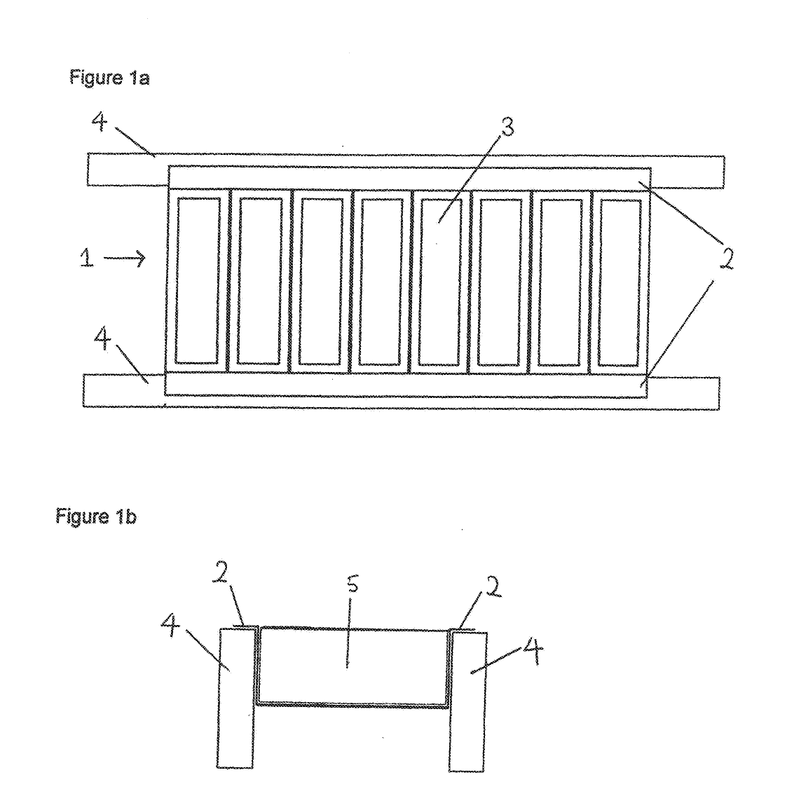

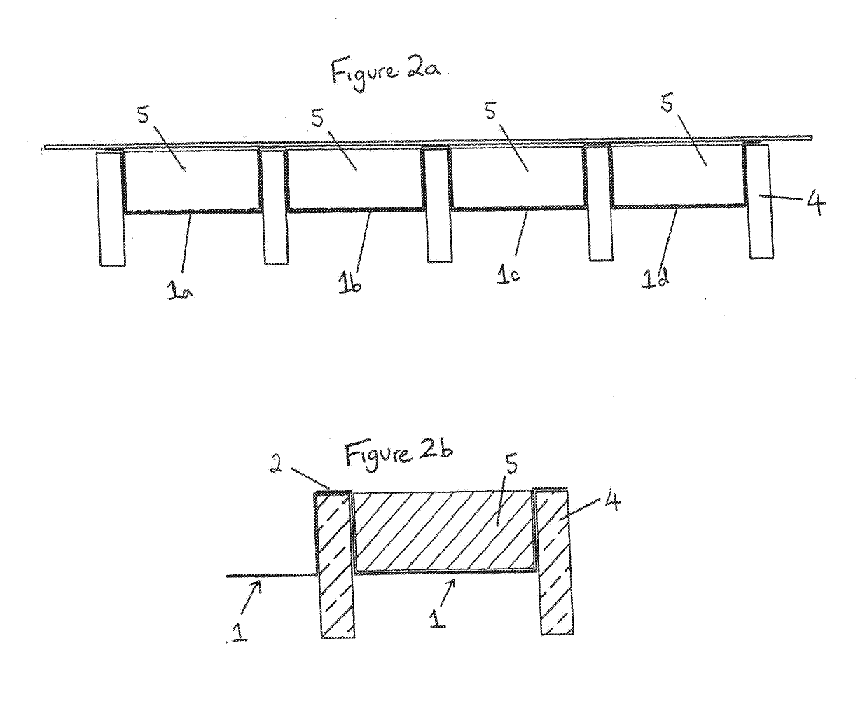

As shown in FIGS. 1a and 1b, an insulation support 1 comprises flanges 2 and troughs 3. The flanges 2 may be stapled or nailed into position on joists 4 or studding in floors, walls and ceilings.

Insulation material 5 is supported within the troughs 3. In the embodiment shown in FIG. 1, the apparatus comprises eight troughs. However, the number of troughs maybe varied. In an alternative embodiment the insulation support 1 may have a single trough 3.

In a preferred embodiment, each trough 3 has ribs moulded into it for strength. The base of the troughs 3 may be solid or may include mesh or other openings to allow the insulation material to breathe. The mesh region may be a plastic type mesh arrangement or, for example, netting material. Similarly, the walls of the troughs 3 may be solid or include openings as different types of insulation have different properties and requirements.

The insulation support 1 may also include holes for electrical cables or water pipes.

The insulation support 1 is preferably made of plastic. Different grades of plastic may be selected according to the particular intended application of the support. In a preferred embodiment, the insulation support 1 is made of double skinned plastic, with an air gap between inner and outer layers of plastic. A suitable material is fluted polypropylene.

Insulation supports 1 may be coded for different sizes or applications, such that they are readily identifiable. For example, insulation supports may be colour coded so that those for use with floors are blue and those for use with walls are coloured brown.

In a preferred embodiment, each support is around one metre in length.

Because floor joists may be spaced at different distances in different buildings and insulation requirements may vary according to the area of type of insulation material, the width and depth of the supports 1 may be varied.

In use, insulation material 5 is packed into the troughs 3 after supports 1 have been secured in place on joists or wall studding. This means that insulation can be laid very quickly because there is no need to screw additional supports to the joists. The supports, which are preferably around 1 m long, can simply be laid between joists and stapled in place. In this way a large area can be covered very quickly.

Alternatively, the support 1 and insulation 5 may be a ready-made unit that can be applied to floors, walls or ceilings in a single step. This means that insulation supports and insulation may be laid directly onto joists simultaneously.

The insulation 5 is packed tightly against the walls of the troughs 3, which secures it in position.

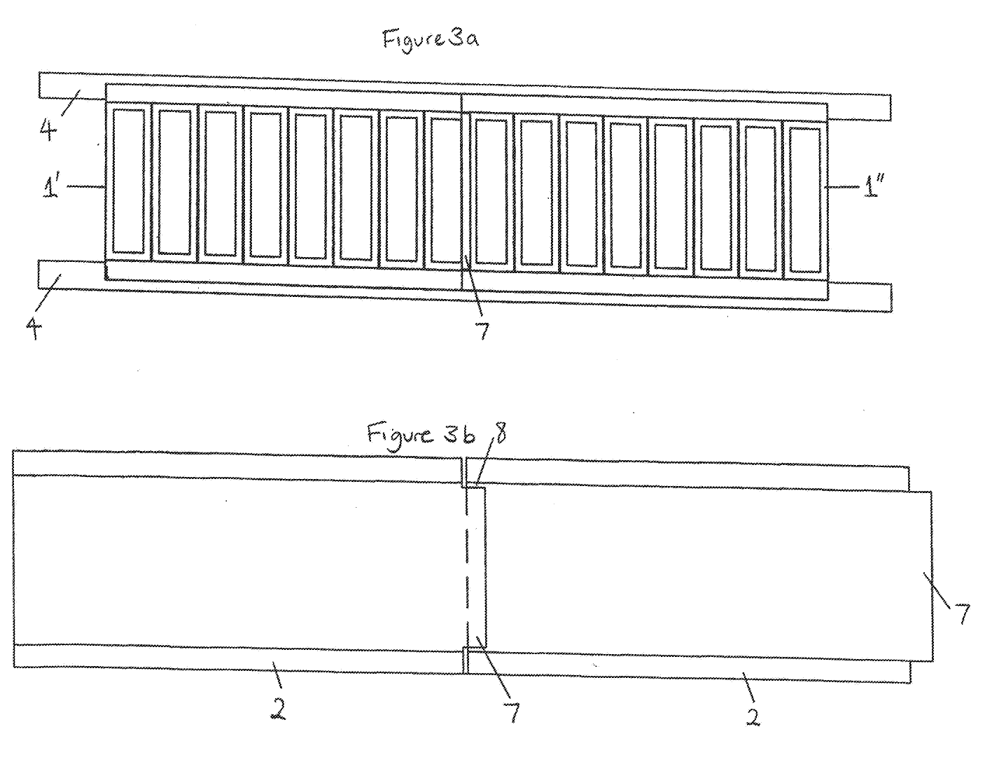

FIG. 2a shows a side view of a number of supports 1a, 1b, 1c and 1d, holding insulation 5 between floor joists 4. Flooring 6 such as wooden flooring is laid over the floor joists 4.

This arrangement is beneficial because if work needs to be carried out after insulation and/or flooring has been laid, the flooring and/or supports 1 in a particular region can be removed and replaced without affecting insulation under the rest of the floor. If pipes or cables need to be laid in a section of the insulation layer, the supports 1 can be removed and holes can be drilled in the necessary parts of the supports.

The supports 1 may have holes pre-drilled in them.

The supports 1 are arranged in rows between floor joists 4. As illustrated in FIG. 2b, the flanges 2 cover substantially the entire width of the joists 4 and flanges 2 of supports in adjacent rows overlap.

In a preferred embodiment each flange 2 is around 50 mm wide.

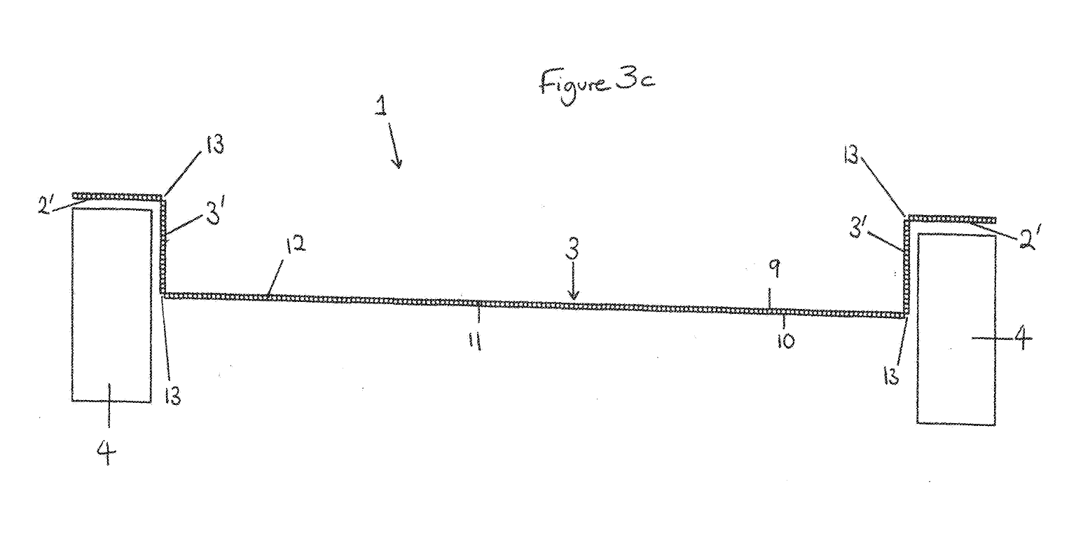

FIGS. 3a and 3b show two adjacent supports 1′ and 1″ in the same row. They are positioned between two joists 4.

The adjacent ends of the supports 1 in the same row are shaped such that they fit together. At one end of support 1′, an extending portion 7 is arranged to overlap a receiving portion 8 at the end of the adjacent support 1″. The length of the extending portion 7 and hence the region of overlap with the receiving portion 8 is preferably around 50 mm.

These complementary flanges 2 and extending/receiving portions 7,8 make laying the supports in the correct positions easier and ensures that insulation material is evenly distributed. Adjacent flanges 2 may be overlapping and/or interlocking. Similarly, adjacent extending portions 7 and receiving portions 8 may be shaped such that they overlap and/or interlock.

The supports 1 may be stackable for storage and the flanges 2 may cooperate in the stacked position to strengthen a stack of supports 1.

Sound insulating or sound deadening materials (not shown) may be added to one or more sides of the supports 1. This could be applied using sound deadening adhesive tape. In a preferred embodiment sound deadening materials are applied to the base of the trough 3 and to one of the flanges 2.

As shown in FIG. 3c, the support 1 is formed from a double skinned material, such as double skinned plastic. This has an inner layer 9 and an outer layer 10. An air gap 11 between the layers of plastic provides additional insulation and the double skinned material is strong such that the support 1 will not bend under the weight of insulating material. Extra support and strength is provided by ribs 12 between the layers 9 and 10. The material provides improved rigidity over single layer materials.

The support may be cut or scored to allow folding. Preferably a cut is made in one of the layers 9 or 10 at points 13 shown in FIG. 3c. This allows the support 1 to be folded for storage, such that the side walls 3′ of each trough may be laid flat against the base of the trough 3 and each of the surfaces 2′ of the flanges 2 may be folded down flat against the side walls 3′. This allows supports 1 to be stacked substantially flat against each other when stored. Alternatively, the supports may be stackable in an in use position or in a partially folded position.

When a support 1 is removed from the flat pack storage position, it is biased such that it assumes the configuration shown in FIG. 3c in which it is ready for use. The double skinned material and score lines or cuts facilitate a “pop up” action into an in use position when a support is removed from storage. A cut or score in one surface of the double skinned material weakens it to allow contraction of material about a corresponding point in the opposite surface, which causes the support to assume the “in use” configuration shown in FIG. 3c.

The cut or score line causes a weakening at a point in one layer of the double skinned material so that the material about the corresponding point in the opposite surface is of greater strength. In alternative embodiments, the weakening or strengthening of areas of the double skinned material may be created by means other that cuts or score lines, for example, by stamping the material. Furthermore, the cuts or score lines may not be continuous cuts or scores along the material.

The cut or score line may run parallel to the grain in the plastic sheets. However, this could cause problems during the manufacturing process, since if the cut or score is not precisely parallel and cuts across more than one grain in the plastic, the ability of the sheet to fold may be affected. This may be overcome by manufacturing the supports 1 by cutting or scoring in a direction perpendicular to the grain of the plastic sheet.

The double skinned plastic provides benefits for acoustic insulation. At the floor joists, flanges 2 of adjacent supports 1 over lap, providing two air gaps 10 in double skinned layers under the floor boards. Because the air gap 10 has insulating properties, less insulation material may need to be added to the trough 3.

The support 1 may be made using recycled plastic material. The flanges 2 may include indicia to show a user where to attach it to joists.

Depending on the building methods used in particular countries, it may be preferable to fit the insulation supports from below the joists 4. As illustrated in FIG. 5, the support 1 may be attached to a joist with flanges 2 on the top surfaces of the joist, or may be attached such that the surfaces 2′ of the flanges 2 are attached to the lower surfaces of joists and insulation may be packed into the trough and/or on top of the underside of the trough 3, between the joists, as shown in FIG. 5.

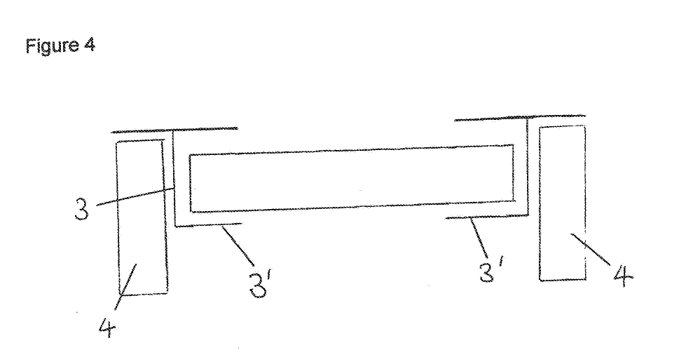

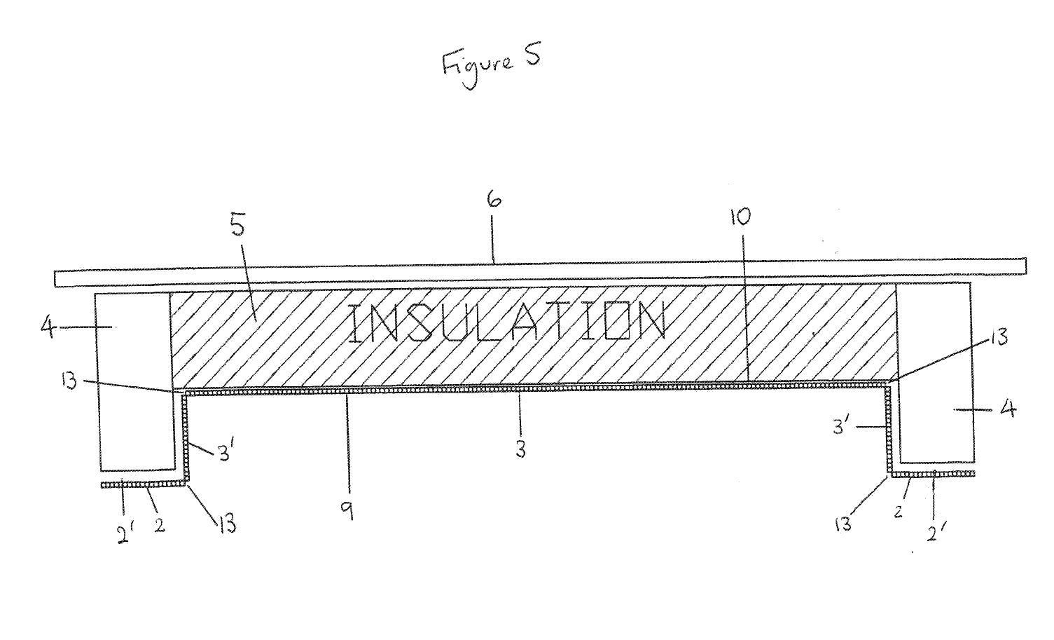

FIG. 4 shows an alternative embodiment of the invention in which the trough 3 of the support 1 has partial wall or base elements 3′.

In an alternative embodiment the supporting flanges 2 may be formed separately from the trough 3. The flanges 2 may be in the form of hooks or clips that attach to the joists and the side walls of the troughs 3.

1. Apparatus for supporting insulation comprising a base portion, at least one side wall and at least one supporting flange, wherein in an in use position the at least one side wall is substantially perpendicular to the base portion and in a storage position the at least one side wall and the at least one supporting flange are substantially parallel to the base portion.

2. Apparatus as claimed in claim 1, wherein the apparatus is biased towards the in use position.

3. Apparatus as claimed in claim 2, wherein at least one cut or score line facilitates biasing of the apparatus towards the in use position.

4. Apparatus as claimed in claim 3, wherein the apparatus is formed substantially from double skinned material.

5. Apparatus as claimed in claim 4, wherein the double skinned material comprises a first surface layer and a second surface layer having connecting elements therebetween.

6. (canceled)

7. Apparatus as claimed in claim 4, further comprising at least one cut or score line in the first surface layer and at least one cut or score line in the second surface layer.

8. Apparatus as claimed in claim 7, wherein the cut or score line forms a pivot point about which the apparatus is pivotable.

9. Apparatus as claimed in claim 1, wherein the at least one supporting flange is pivotable towards the at least one side wall.

10. Apparatus as claimed in claim 1, wherein the at least one side wall is pivotable towards the base portion.

11. Apparatus as claimed in claim 1, wherein the at least one supporting flange is adapted to engage a structural element of a building.

12. Apparatus as claimed in claim 1, wherein, in use, adjacent supporting flanges overlap.

13. Apparatus as claimed in claim 1, wherein, in use, adjacent supporting flanges interlock.

14. Apparatus as claimed in claim 1, wherein openings are arranged to accommodate pipes or cables.

15. Apparatus as claimed in claim 1, further comprising sound deadening elements.

16. Apparatus as claimed in claim 1, further comprising insulating material.

17. Apparatus for supporting insulation comprising a base portion and at least one side wall, wherein in an in use position the at least one side wall is substantially perpendicular to the base portion and in a storage position the at least one side wall is parallel to the base portion and wherein the apparatus is formed substantially from double skinned material.

18. Apparatus as claimed in claim 17, wherein a portion of one surface layer of the double skinned material is substantially weaker than a corresponding portion of the other surface layer.

19. An insulation system, comprising more than one apparatus for supporting insulation as claimed in claim 1, wherein each apparatus for supporting insulation is coded according to its properties.

20. An insulation system, as claimed in claim 19, wherein each apparatus for supporting insulation is colour coded according to its properties.

21. A method of insulating a structure, comprising the steps of:
a. engaging at least one supporting flange of an apparatus for supporting insulation as claimed in claim 1 with a structural element of a building; and
b. securing the apparatus to the structural element of the building.

22. An insulated structure comprising a plurality of support elements, at least one apparatus as claimed in claim 1 and insulating material.

23. A method of manufacture of apparatus for supporting insulation comprising the steps of:
i) cutting or scoring a first surface of a double skinned material to define a supporting flange portion; and
ii) cutting or scoring a second surface of a double skinned material to define a side wall portion and base portion.

24. (canceled)
